(19) United States
(12) Patent Application Publication
(10) Pub. No.: US 2003/0081377 A1
(43) Pub. Date: May 1, 2003

(54) Modular gateway configuration

(76) Inventor: David D. Lin, San Jose, CA (US)

Correspondence Address: Gregory Smith & Associates, Suite 317, 3900 Newpark Mall Road, Newark, CA, 94560, US

(21) Appl. No.: 10/305,202

(22) Filed: Nov. 25, 2002

Related U.S. Application Data
(63) Continuation-in-part of application No. 09/794,809, filed on Feb. 26, 2001.
(60) Provisional application No. 60/241,780, filed on Oct. 18, 2000.

(51) Int. Cl. G06F 1/16

(52) U.S. Cl. 361/683; 361/724

(57) ABSTRACT

A modular router forms the base for one or more stackable modules. The modules may take on various communication and data transfer forms such as modems, additional routers, VoIP module, etc. Each module has at least two legs, which hold the module up from the top surface of the router. The modules are connected to the router by a connector having a first portion located on a top surface of the router and a mating second portion located on a bottom surface of the module. One or both of the connector portions extend outward such that the connector will properly mate when the legs of the module are resting in depressions in the top surface of the router. Either of two interchangeable lids may be used with the router. The first lid is shallow and is used when the router is used without any modules. The second lid is much deeper and may be used to cover the unit with two modules. The back wall of the second lid has one or more access openings to allow users easy access to ports in frequent use. Insert panels may be placed in these openings to cover less used connectors or blank areas.

### CROSS REFERENCE TO OTHER APPLICATIONS

This application is a continuation-in-part of U.S. Utility application No. 09/794,809 filed Feb. 26, 2001, which claims the benefit of U.S. Provisional Application No. 60/241,780 filed Oct. 18, 2000, and this application is a continuation-in-part of U.S. Utility application No. 09/994,451 filed Aug. 30, 2001, which claims the benefit of U.S. Provisional Application No. 60/304,546 filed Jul. 10, 2001. The specifications and drawings of these applications are hereby incorporated by reference in their entirety.

### FIELD OF INVENTION

The present invention relates to a configuration for a modular gateway system. More particularly, it relates to the configuration of a modular router base and one or more modules.

### BACKGROUND OF THE INVENTION

The connection between computers has evolved from simple connections to complex networks needing sophisticated routing protocols, protocol converters to connect heterogeneous networks and computers to help with network services such as address management, network management, and traffic monitoring. The cost of owning these networks is high, requires skilled employees, and is difficult to change.

Communications networks that were once restricted to businesses are now moving into the residential environment. The deployment of residential high-speed communications has begun using Cable modems, ADSL, and wireless MAN technologies. These communications technologies carry not only computer data, but also voice and video services. It is very likely that residences will need to distribute this data to more than just a single device and therefore will need a residential communications network.

While consumers desire to obtain the benefits provided by communication networks, the technology used by today's businesses may not be readily applied to the residence.

Attempts have been made to create a simple residential gateway modular system, but prior attempts have not been universally accepted in the market. Obstacles to the acceptance of residential gateways include: (a) generally high initial cost of the enclosure, power, and control modules, (b) cost and effort required to wire the gateway to all the places in the home that the information is needed, (c) difficulty in supplying backup power for life-line services when the main power fails, (d) the generally high level of technical skill required to configure and diagnose problems and (e) the high cost of adding new modules as new networking technologies evolve. What is needed is a modular gateway network system that avoids the limitations and problems inherent in prior art attempts.

### SUMMARY OF THE INVENTION

The present invention takes the form of a modular router that forms the base for one or more modules connected thereto. The modules may take on various communication and data transfer forms such as modems, additional routers, VoIP module, etc. Each module has at least two legs located at or near the sides of the module. The legs hold the module up from the top surface of the router to provide air circulation for temperature control purposes. The modules are connected to the router by a connector having a first portion located on a top surface of the router and a mating second portion located on a bottom surface of the module. One or both of the connector portions extend outward from their respective surfaces and are sized such that the connector will properly mate when the legs of the module are resting on the top surface of the router. Depressions may be located in the top surface of the router to assist with placement and stability of the modules placed thereon.

Either of two interchangeable lids may be used with the router. The first lid is shallow and is used when the router is used alone or without any modules stacked thereon. The second lid is much taller and may be used to cover the unit with up to two modules connected thereto. The back wall of the second lid has one or more cutouts or access openings to allow users easy access to ports and connectors in frequent use. If desired insert panels may be placed in these openings to cover less used connectors or blank areas, thereby minimizing the likelihood that a user will become confused by the number of accessible ports.

### BRIEF DESCRIPTION OF THE DRAWINGS

FIGS. 1A-D show the modular router of the present invention.

FIGS. 2A-J depict the USB ADSL modem module.

FIGS. 3A-G are views of an Ethernet ADSL modem module.

FIG. 4 shows the cable modem module.

FIG. 5 shows of the VoIP module.

FIGS. 6A-I are views of the assembled system.

FIGS. 7A and 7B are views of the assembled system with the insert panels installed.

FIGS. 8A and 8B are exploded views of the system.

### DETAILED DESCRIPTION OF THE INVENTION

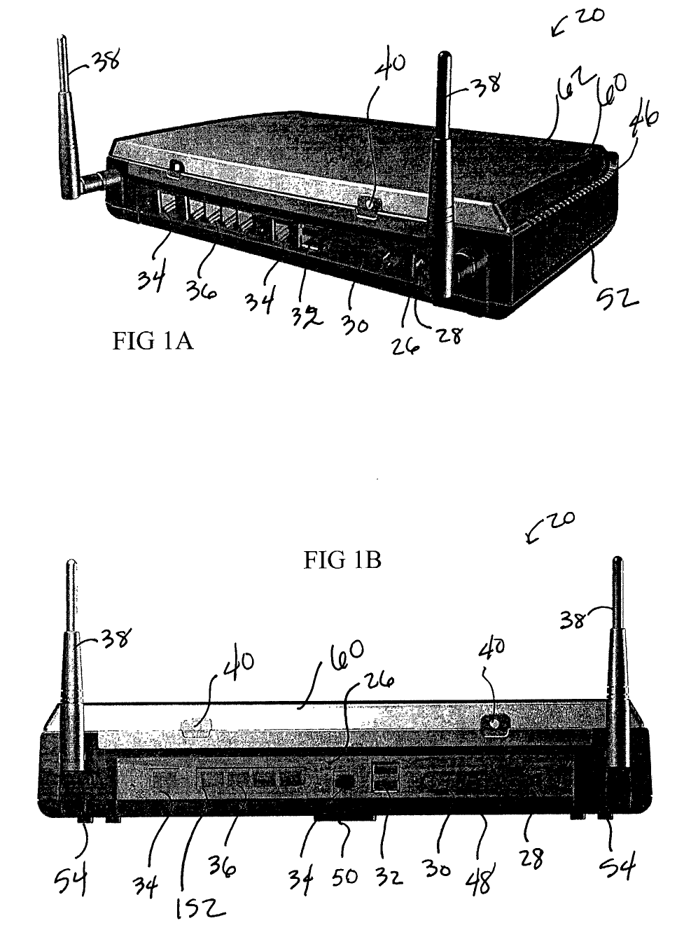

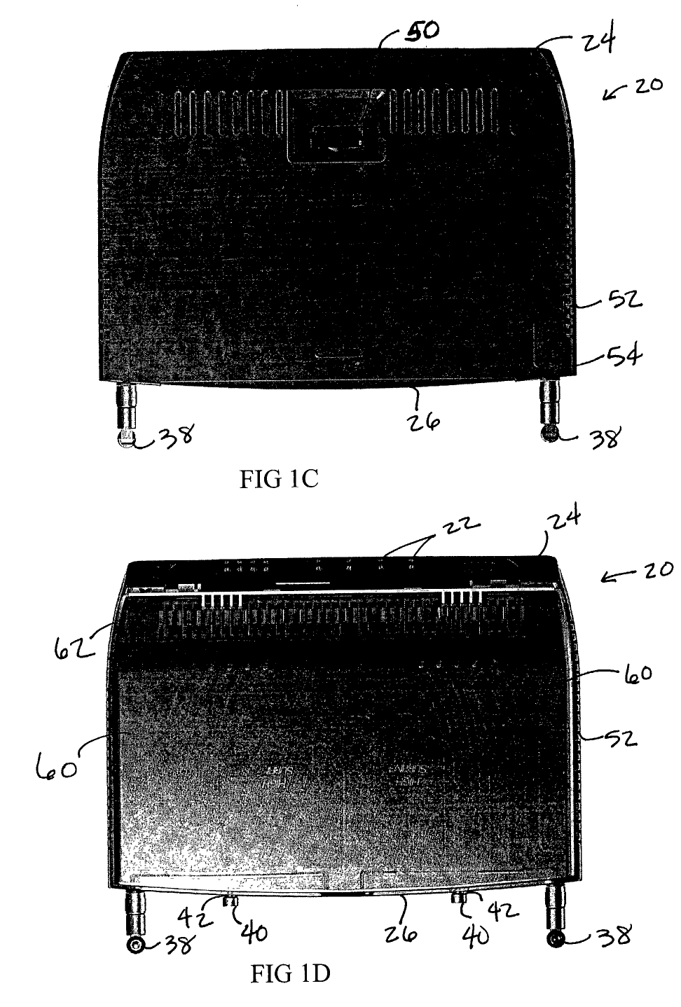

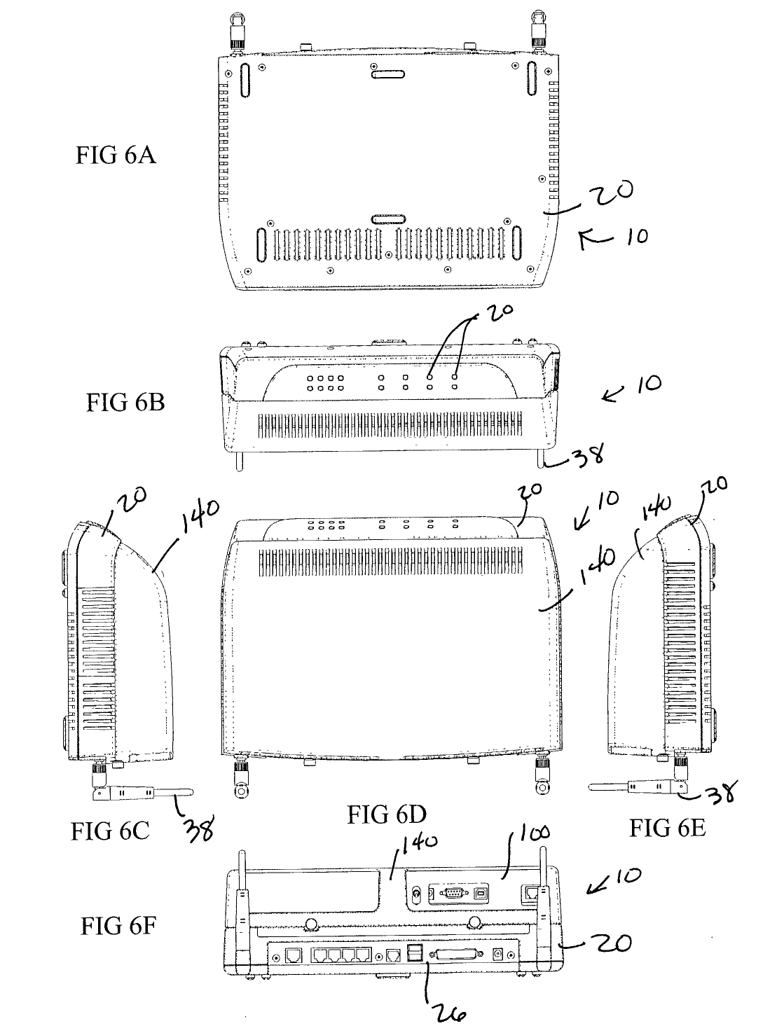

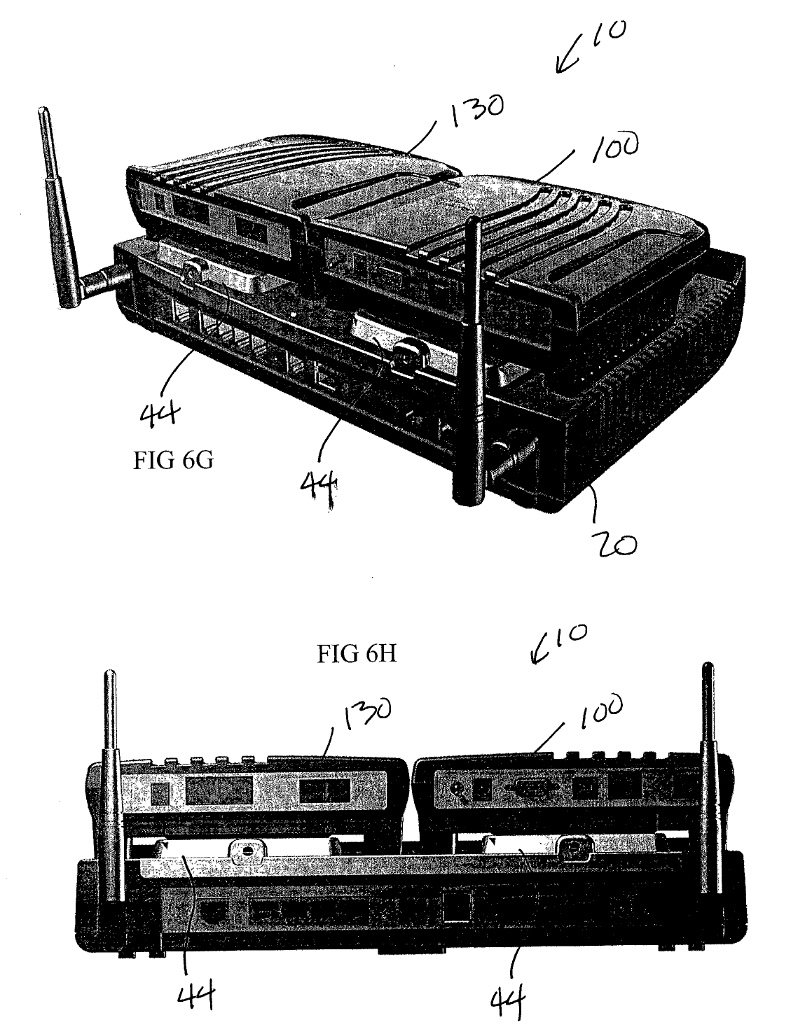

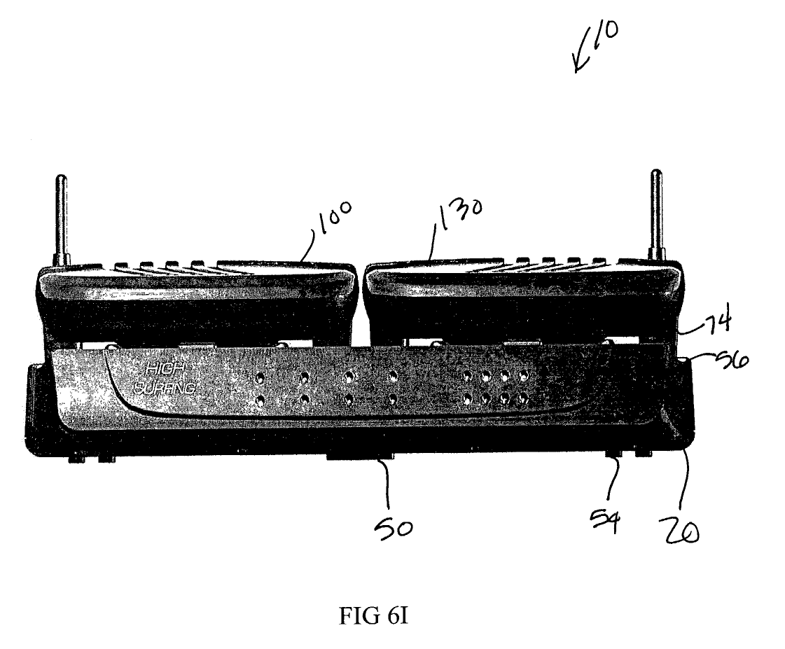

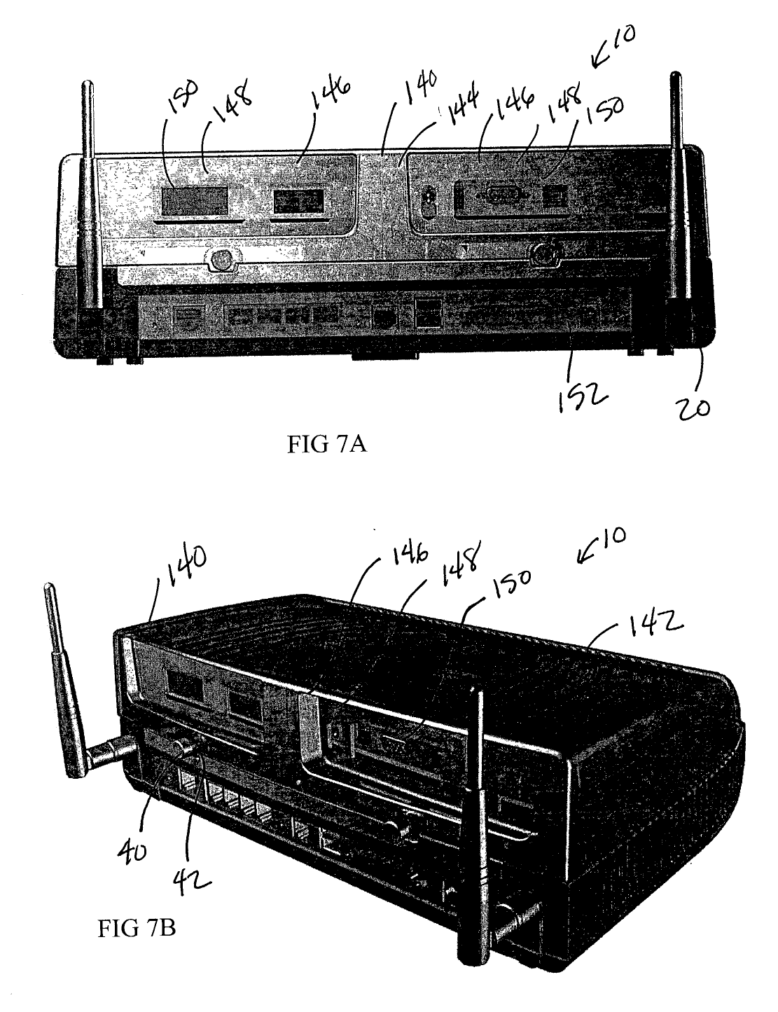

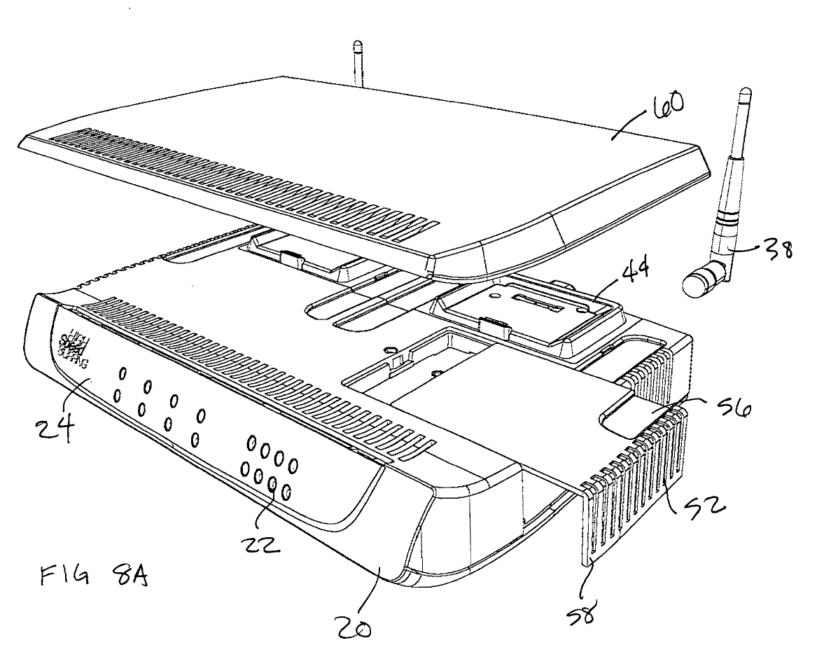

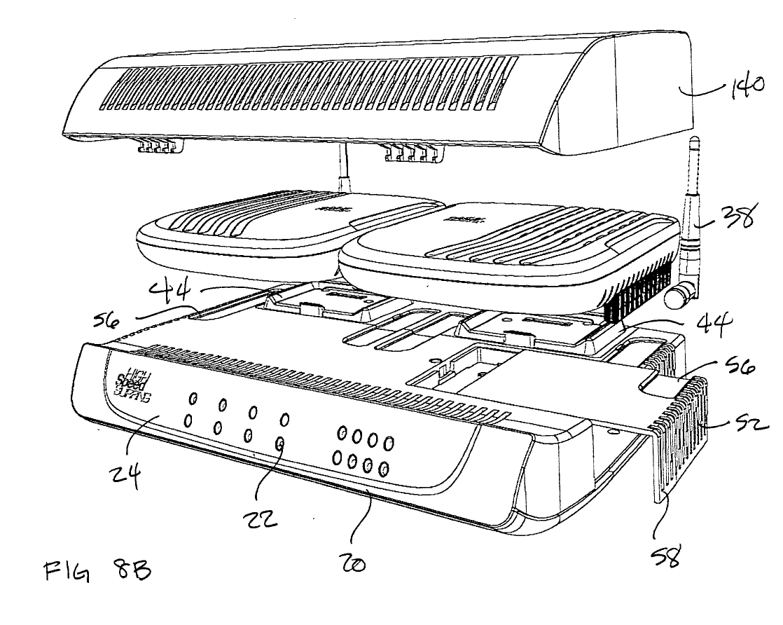

FIG. 1A is a rear perspective view of the router 20, FIG. 1B is a rear view thereof, FIG. 1C is a bottom view thereof and FIG. 1D is a top view thereof. FIGS. 6A-F are orthographic projections of an assembled system 10, including the router 20, two modules 100, 130 and the lid 140. FIG. 6G is a rear perspective view of an assembled system 10 with the lid 140 removed, FIG. 6H is a back view thereof and 6I is a front view thereof. FIGS. 7A and B are rear and perspective views of the assembled system 10 with the insert panels 148 installed. FIGS. 8A and 8B are exploded views of the system 10 without and with modules.

The router 20 has a plurality of status light emitting diodes (LED's) 22 located on the front 24 of the router unit 20. The connection ports for communication within or outside the modular electronic communication system 10 are located on the back 26 of the router 20. Although other connections could be used for connection with other types of equipment, the router 20 shown has a AC adaptor port 28, a 25-pin printer serial port 30, a USB port 32, two telephone (DSL) RJ-11 jacks 34 and four Ethernet RJ-45 jacks 36 located between the two RJ-11 jacks 34. There are also two antennas 38 for wireless communication with remotely located modules and electronic devices, such as laptops. Both antennas 38 are used for transmitting and receiving signals.

Also extending from the back 26 of the router 20 are two optional lid supports 40. The lid supports 40 may be any convenient shape and may have a necked down portion 42 or a groove in the top for holding the bottom edge of the back wall of the lid 60, 140, which is described below.

The local modules, described in further detail below, are connected to the router 20 with a specialized module connector 44 located on the top surface 46 of the router 20. The module connector 44 is used to provide one or more of power, data transfer and grounding to the module that is connected thereto. If the connector 44 is used to provide a data signal, the signal may be interfaced through either Ethernet or USB communications media. The module connector 44 may be located anywhere on the top surface 46 of the router 20, but is located to match with the configuration of the mating connector located on the module. In the embodiment shown, the module connector 44 is located at or near the back of the top surface 46 of the router 20.

The bottom 48 of the router 20 may have an additional connector 50, which may be similar in structure to the module connector 44, for connecting to an additional module (not shown) upon which the router 20 could rest. The additional module would have a footprint similar in size to the router 20 and would have a corresponding connector located on the top surface of the additional module.

The shape of the router 20 may be changed, if desired. For example, the sidewalls of the router 20 may be vertical or they may taper inward slightly as shown. The front 24 of the router 20 may have comers or it may be rounded to give the router 20 an ergonomic appearance. The number and placement of the air ventilation openings 52 may alter for particular environments. The current configuration of openings 52 is designed for typical residential applications. A plurality of feet 54 extend downward from the bottom surface 48 of the router 20 to elevate the router 20 from the surface, such as a table, another router or other equipment, on which the router 20 is resting. The feet 54 allow air to circulate beneath the router 20 to remove any excess heat generated by the unit 20.

FIGS. 1A-1D also show a lid 60, which is one of the two optional lids that may be used with the router 20. This lid 60 is shallow and is used when the router 20 is used alone or without any modules stacked thereon. The lid 60 has a set of air ventilations openings 62 located above the air ventilation openings 52 on the top surface 46 of the router 20. The remainder of the lid 60 is solid. The front and side walls of the lid 60 rest on the top surface 46 of the router 20. The back wall of the lid 60 rests partially on the lid supports 40, if present, and partially on the top surface 46 of the router 20.

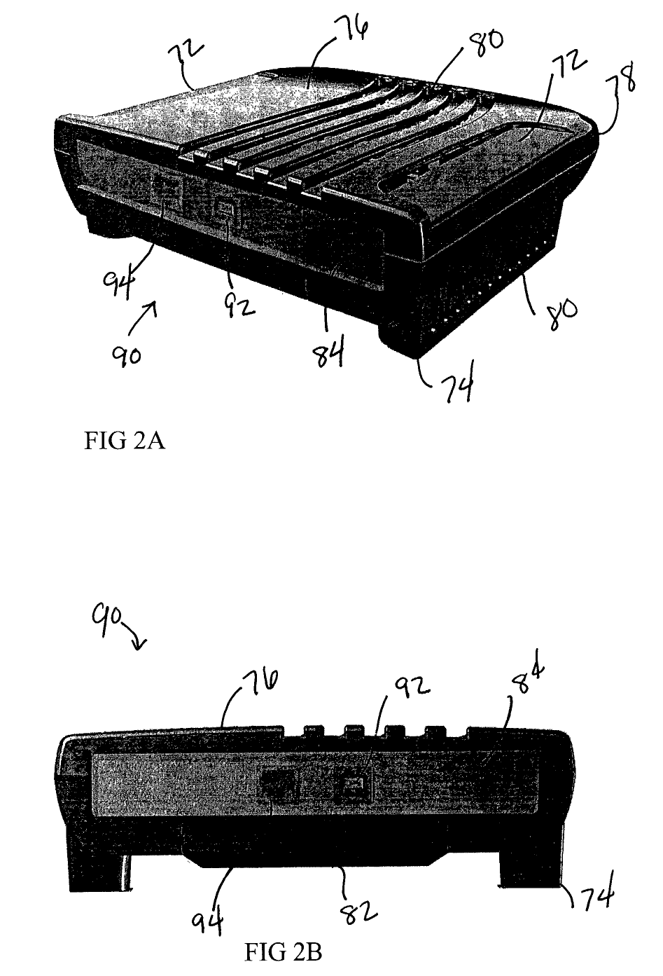

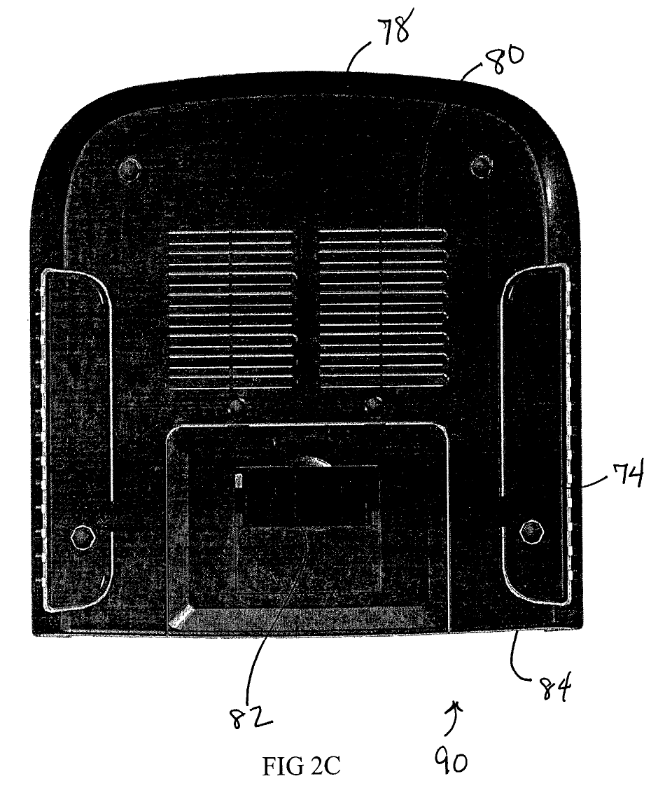

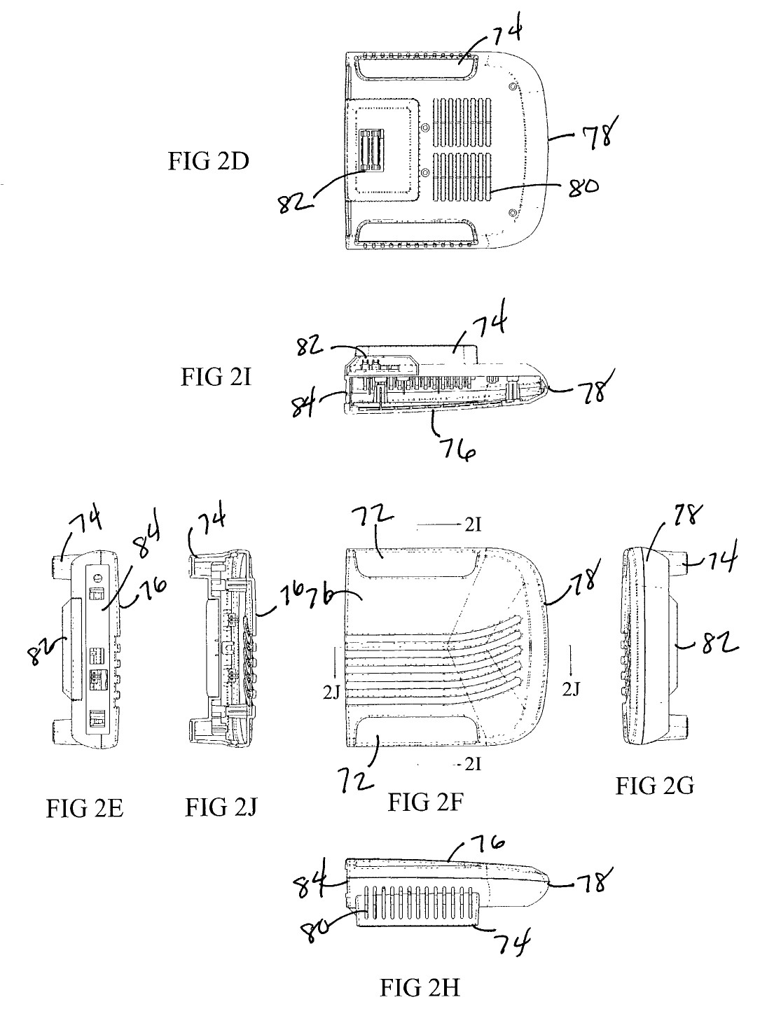

The modules 90, 100, 120, 130 may take on several forms, as seen in FIGS. 2A-5. The shape of each module 90, 100, 120, 130 case is similar or the same. The top 76 and/or front 78 surfaces of the module 90, 100, 120, 130 has a plurality of status LED's 68 that correspond to the functions of the particular module 90, 100, 120, 130. The top surface 76 of the module 90, 100, 120, 130 also has depressions 72 to match the feet 74 of other modules 90, 100, 120, 130, such that additional modules 90, 100, 120, 130 may be stacked thereon to create a tower. The top, bottom and/or sides of the module 90, 100, 120, 130 include air ventilation openings 80 to control temperature and remove excess heat generated by the module 90, 100, 120, 130. The number and location of the air ventilation openings 80 may be standardized through all of the modules 90, 100, 120, 130 or, if preferred, the openings 80 may be configured for the particular needs of the module 90, 100, 120, 130 or surrounding environment.

The bottom surface of the module 90, 100, 120, 130 has feet 74 that extend down.

The version of the modules 90, 100, 120, 130 shown has two longitudinal feet 74 extending from front to back along the sides of the module 90, 100, 120, 130. Alternate versions of the module 90, 100, 120, 130 may include a greater number and/or smaller or larger feet. The bottom surface of each module 90, 100, 120, 130 also has a connector 82 designed to connect with the module connector 44 located on the top surface 46 of the router 20. One or both parts of the module connector 82, 44 may extend from the surface of the respective units. A plurality of ports specific to the particular module 90, 100, 120, 130 is located on the back panel 84 of each module 90, 100, 120, 130 as discussed below.

FIGS. 2A-C are rear perspective, rear and bottom views of the USB ADSL modem module 90. This module 90 is one of the modules that may be placed on the router 20 and connected thereto. The back panel 84 of this module 90 includes a USB connector 92 and a telephone (DSL) RJ-11 jack 94. FIGS. 2D-2H are orthographic projections of a USB ADSL modem module 90 with additional connector openings 96, for other ports such as AC adaptor, a power switch, etc. and FIGS. 2I and 2J are cross-sectional views thereof.

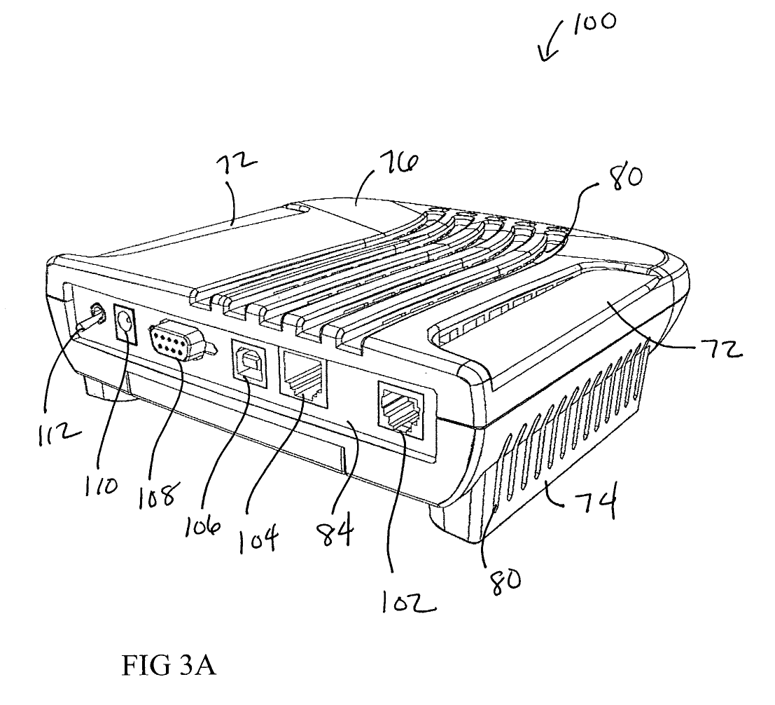

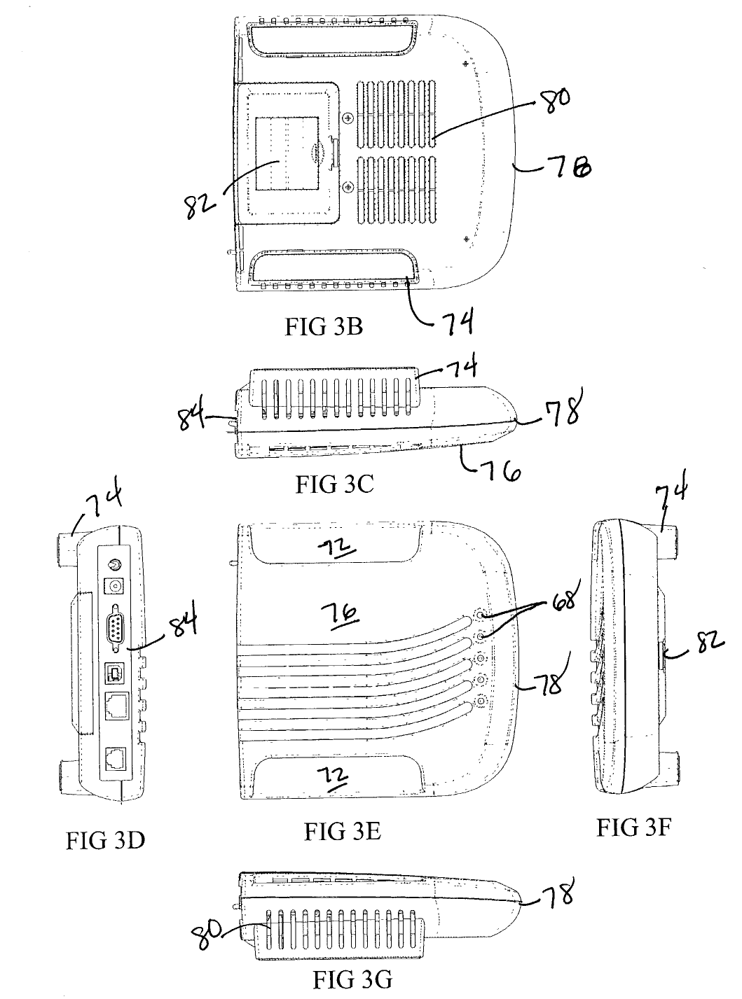

FIG. 3A is a rear perspective view of the Ethernet ADSL modem module 100. FIGS. 3B-G are orthographic projections thereof. The back panel 84 of this module 100 includes a telephone (DSL) RJ-11 jack 102, an Ethernet RJ-45 jack 104, USB connector 106, a DB-9 female serial port 108, an AC adaptor port 110 and a power switch 112.

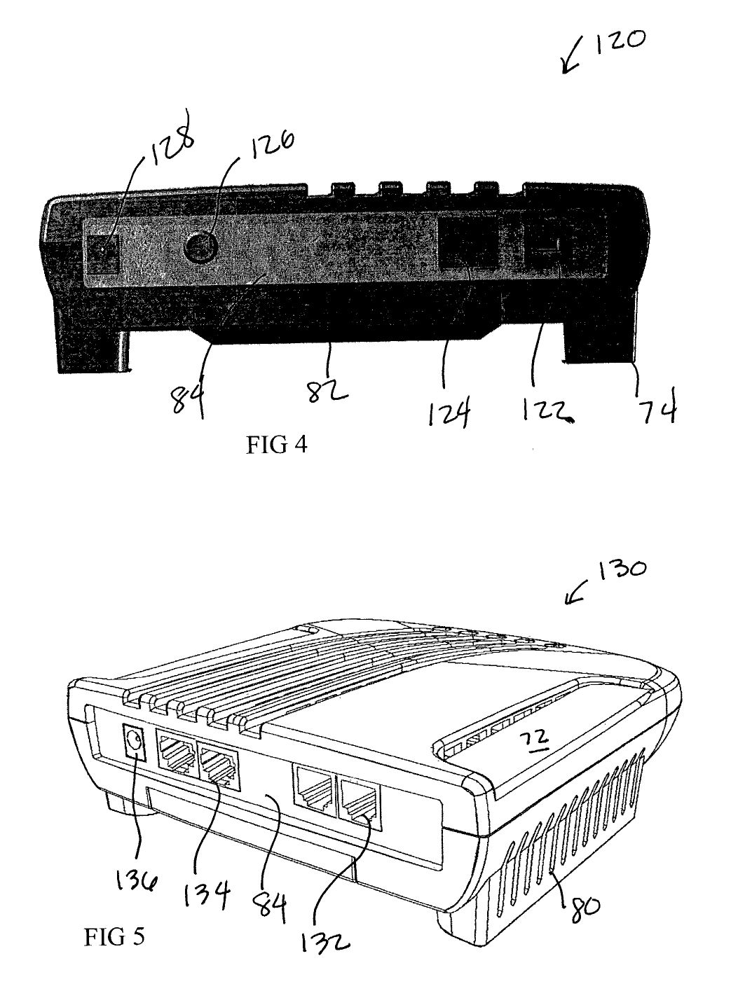

FIG. 4 shows the cable modem module 120. The back panel 84 of this module 120 includes USB connector 122, an Ethernet RJ-45 jack 124, a screw-on co-ax cable port 126 and an AC adaptor port 129.

FIG. 5 shows the VoIP module 130. The back panel 84 of this module 130 includes two RJ-11 telephone jacks 132, two Ethernet RJ-45 jacks 134 and AC adaptor port 136.

Other modules may be created to perform other functions. For example additional modules may take the form of an entertainment module, such as a personal video recorder (PVR) or set-top box module. This type of module would use a 20-pin connector.

FIGS. 7A and 7B are views of the assembled system 10. In these view there are two modules 100, 130 resting on and connected to the top surface 46 of the router 20. Covering the top 46 of the router 20 and the two modules 100, 130 is a second version of the lid 140. In this case, the lid 140 is taller to accommodate the modules 100, 130. A row of air ventilation openings 142 extends across the curved front wall of the lid 140. Similar to the shallow lid 60, the tall lid 140 rests on the top surface 46 of the router 20 and the lid supports 40, if present. The back wall 144 of the lid 140 has two access openings 146 for access to the back of the modules 90, 100, 120, 130. If desired, an insert panel 148 may be placed within one or both of the access openings 146. The insert panel 148 may be made solid or with one or more openings 150 to allow the user access to frequently used ports. The insert panel 148 may cover some of the less used ports, thereby decreasing the likelihood that a user will be confused by the number of accessible ports. Specific insert panels 148 may be created for each type of module 90, 100, 120, 130. When the module 90, 100, 120, 130 is obtained, the user would also receive the appropriate insert panel 148. During installation of the module 90, 100, 120, 130 on top 46 of the router 20, the user would place the insert panel 148 in the corresponding access opening 146 of the lid 140. If full access is needed to the back of the module 90, 100, 120, 130, the lid 140 is used without one or both of the insert panels 148. Although other mechanisms may be used, the current embodiment uses snap-in assembly for installation of the insert panels 148.

Additional removable port cover panels 152 may be used to cover ports on the router 20 or modules 90, 100, 120, 130 in cases where specific ports are not being used. These port cover panels 152 may be seen in FIGS. 1B, 2A, 2B, 6H and 7A. Although other mechanisms may be used, the current embodiment uses snap-in assembly for installation of the port cover panels 152.

FIGS. 8A and 8B are exploded views of the system 10. The top surface 46 of the router 20 may also include depressions 56 to assist in proper placement and stability of any modules 90, 100, 120, 130 placed on the router 20. The depressions 56 are sized and located to match the size and location of the feet 74 extending downward from the modules 90, 100, 120, 130. The distance the parts of the module connector 44, 82 extend from the module 90, 100, 120, 130 and router 20 is matched with the height of the feet 74 of the module 90, 100, 120, 130 and the depth of the depression 56, such that when the parts of the module connector 44, 82 are aligned and the feet 74 of the module 90, 100, 120, 130 are resting within the depressions 56 in the top 46 of the router 20, the module connector 44, 82 is fully connected.

An access panel 58 may be used to access the internal cavity of the router 20 for maintenance or to upgrade or switch out components. For example, depending on the content and configuration of the internal cavity, ports for PCMCIA or PCI may be accessed through the access panel 58. Although the access panel 58 may take on other configurations, in the embodiment shown, the access panel 58 forms part of the top 46 and side panels of the router 20 case. These views also show alternate version of the module connector 44, 82 previously described.

Many features have been listed with particular configurations, options, and embodiments. Any one or more of the features described may be added to or combined with any of the other embodiments or other standard devices to create alternate combinations and embodiments.

Although the examples given include many specificities, they are intended as illustrative of only a few possible embodiments of the invention. For example, although the term router has been used, the router may be combined with a firewall or other equipment. Other embodiments and modifications will, no doubt, occur to those skilled in the art. Thus, the examples given should only be interpreted as illustrations of some of the preferred embodiments of the invention, and the full scope of the invention should be determined by the appended claims and their legal equivalents.

What is claimed is:

1. A modular electronic communication system, comprising:
a module having a bottom surface and a top surface and including:
a first plurality of status LED's located on said top surface,
a pair of legs extending from said bottom surface,
a first part of a two-part connector extending from said bottom surface,
a router having a front surface, a top surface and a bottom surface and including:
a second plurality of status of LED's located on said front surface,
a pair of depressions in said top surface of said router sized and configured for said pair of legs to rest therein,
a second part of said two-part connector extending upward from said top surface of said router,
a plurality of feet extending from said bottom surface of said router,
wherein a height of the at least two legs is such that said first and second parts of said two-part connector connect when said legs of said module are resting in said pair of depressions in said top surface of said router.

2. The modular electronic communication system of claim 1, further comprising a lid, said lid covering said top surface of said router and module.

3. The modular electronic communication system of claim 2, wherein a back surface of said module has a plurality of ports and a back wall of said lid has an access opening to allow access to at least one of said plurality of ports.

4. The modular electronic communication system of claim 3, further comprising a panel insert sized and configured to fit into said access opening.

5. The modular electronic communication system of claim 4, wherein said panel insert has at least one port opening to allow access to at least one of said plurality of ports on said back wall of said module.

6. The modular electronic communication system of claim 5, wherein said panel insert covers at least one of said plurality of ports on said back wall of said module.

7. The modular electronic communication system of claim 1, further comprising a port cover panel sized and configured to cover one or more of said plurality of ports on said router.

8. The modular electronic communication system of claim 1, further comprising a port cover panel sized and configured to cover one or more of said plurality of ports on said module.

9. The modular electronic communication system of claim 1, wherein said module is a module chosen from the group of modules consisting of a USB ADSL modem module, an Ethernet ADSL modem module, a cable modem module and a VoIP module.

10. The modular electronic communication system of claim 1, further comprising a first part of a second two-part connector extending from a bottom surface of said router.

11. A modular electronic communication system, comprising:
a first module having a first bottom surface and a first top surface and including:
a first plurality of status LED's located on said first top surface,
a first pair of legs extending from said first bottom surface,
a first part of a first two-part connector extending from said first bottom surface,
a second module having a second bottom surface and a second top surface and including:
a second plurality of status LED's located on said second top surface,
a second pair of legs extending from said second bottom surface,
a first part of a second two-part connector extending from said second bottom surface,
a router having a front surface, a top surface and a bottom surface and including:
a third plurality of status of LED's located on said front surface,
a first pair of depressions in said top surface of said router sized and configured for said first pair of legs to rest therein,
a second part of said first two-part connector extending upward from said top surface and located between said first pair of depressions,
a second pair of depressions in said top surface sized and configured for said second pair of legs to rest therein,
a second part of said second two-part connector extending upward from said top surface and located between said second pair of depressions,
a plurality of feet extending from said bottom surface of said router, wherein a height of said first pair of legs is such that said first and second parts of said first two-part connector connect when said first pair legs of said first module are resting in said first pair of depressions in said top surface of said router, and wherein a height of said second pair of legs is such that said first and second parts of said second two-part connector connect when said second pair of legs of said second module are resting in said second pair of depressions in said top surface of said router.

12. The modular electronic communication system of claim 11, further comprising a lid, said lid covering said top surface of said router and said first and second modules.

13. The modular electronic communication system of claim 12, wherein a back surface of said first module has a first plurality of ports and a back wall of said lid has a first access opening to allow access to at least one of said first plurality of ports and wherein a back surface of said second module has a second plurality of ports and said back wall of said lid has a second access opening to allow access to at least one of said second plurality of ports.

14. The modular electronic communication system of claim 13, further comprising a panel insert sized and configured to fit into said first access opening and a second panel insert sized and configured to fit into said second access opening.

15. The modular electronic communication system of claim 14, wherein said first panel insert has at least one port opening to allow access to at least one of said first plurality of ports on said back wall of said first module and said second panel insert has at least one port opening to allow access to at least one of said second plurality of ports on said back wall of said second module.

16. The modular electronic communication system of claim 15, wherein said first panel insert covers at least one of said plurality of ports on said back wall of said first module and wherein said second panel insert covers at least one of said plurality of ports on said back wall of said second module.

17. The modular electronic communication system of claim 1 1, further comprising a port cover panel sized and configured to cover one or more of said plurality of ports on said router.

18. The modular electronic communication system of claim 11, further comprising a port cover panel sized and configured to cover one or more of said plurality of ports on said first module.

19. The modular electronic communication system of claim 11, wherein said first and second modules are modules chosen from the group of modules consisting of a USB ADSL modem module, an Ethernet ADSL modem module, a cable modem module and a VoIP module.

20. The modular electronic communication system of claim 1, further comprising a first part of another two-part connector extending from a bottom surface of said router.
